(19) United States
(12) Patent Application Publication
(10) Pub. No.: US 2026/0030742 A1
(43) Pub. Date: Jan. 29, 2026

(54) UNLABELED DEFECT DETECTION FOR SEMICONDUCTOR EXAMINATION

(71) Applicant: Applied Materials Israel Ltd., Rehovot (IL)

(72) Inventors: Nati OFIR, Rehovot (IL); Ran BADANES, Rishon Le-Zion (IL); Boris SHERMAN, Rehovot (IL)

(21) Appl. No.: 18/787,980

(22) Filed: Jul. 29, 2024

(51) Int. Cl. G06T 7/00

(52) U.S. Cl. CPC G06T 7/001; G06T 2207/20081; G06T 2207/20084; G06T 2207/30148

(57) ABSTRACT

There is provided a system and method of runtime defect detection in a semiconductor specimen. The method includes obtaining a runtime image of the specimen; and processing, by a detection network, the runtime image to obtain a defect map indicating probabilities of defect distribution thereof. The detection network is previously trained unsupervised in a training phase, comprising, for a training image: obtaining a reference image of the training image; processing, by a detection network to be trained, the training image to generate a predicted defect map thereof; and optimizing the detection network to be trained using a loss function constructed based on the predicted defect map, and a difference image between the training image and the reference image.

### TECHNICAL FIELD

The presently disclosed subject matter relates, in general, to the field of examination of a semiconductor specimen, and more specifically, to machine-learning based defect detection of a specimen.

### BACKGROUND

Current demands for high density and performance associated with ultra large-scale integration of fabricated devices require submicron features, increased transistor and circuit speeds, and improved reliability. As semiconductor processes progress, pattern dimensions such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Examination can be provided by using non-destructive examination tools during or after manufacture of the specimen to be examined. A variety of non-destructive examination tools includes, by way of non-limiting example, scanning electron microscopes, atomic force microscopes, optical inspection tools, etc.

Examination processes can include a plurality of examination steps. The manufacturing process of a semiconductor device can include various procedures such as etching, depositing, planarization, growth such as epitaxial growth, implantation, etc. The examination steps can be performed a multiplicity of times, for example after certain process procedures, and/or after the manufacturing of certain layers, or the like. Additionally, or alternatively, each examination step can be repeated multiple times, for example for different wafer locations, or for the same wafer locations with different examination settings.

During the examination processes at various steps during semiconductor fabrication, examination images are acquired by the examination tools which are processed for the purpose of examination operations such as detecting and classifying defects on specimens, as well as performing metrology related operations.

Effectiveness of examination can be improved by automatization of process(es) such as, for example, defect detection, Automatic Defect Classification (ADC), Automatic Defect Review (ADR), image segmentation, automated metrology-related operations, etc. Automated examination systems ensure that the parts manufactured meet the quality standards expected and provide useful information on adjustments that may be needed to the manufacturing tools, equipment, and/or compositions, depending on the type of defects identified. In some cases, machine learning (ML) technologies can be used to assist the automated examination process so as to promote higher yield.

### SUMMARY

In accordance with certain aspects of the presently disclosed subject matter, there is provided a computerized system of runtime defect detection in a semiconductor specimen, the system comprising a processing circuitry configured to obtain a runtime image of the specimen; and process, by a detection network, the runtime image to obtain a defect map indicating probabilities of defect distribution thereof. The detection network is previously trained unsupervised in a training phase, comprising, for a training image: obtaining a reference image of the training image; processing, by a detection network to be trained, the training image to generate a predicted defect map thereof; and optimizing the detection network to be trained using a loss function constructed based on the predicted defect map and a difference image between the training image and the reference image.

In addition to the above features, the system according to this aspect of the presently disclosed subject matter can comprise one or more of features (i) to (ix) listed below, in any desired combination or permutation which is technically possible:

(i). The reference image is a synthetic reference image generated by a reconstruction network.

(ii). The reconstruction network is previously trained in a first step of the training phase using a training set comprising one or more pairs of training images, each pair including a defective image and a corresponding defect-free image.

(iii). The reconstruction network is trained by: for each pair of training images, processing the defective image by the reconstruction network to obtain a predicted image, and optimizing the reconstruction network to minimize a difference between the predicted image and the defect-free image.

(iv). The detection network is trained in a second step of the training phase upon the reconstruction network being trained, where the detection network is initialized based on model parameters of the trained reconstruction network.

(v) The loss function comprises a first component calculated as a product or ratio of the difference image and predicted defect map.

(vi). The first component enables to align the predicted defect map with potential defects indicated by the difference image, thus emphasizing regions in the predicted defect map that correlate with significant differences in the difference image.

(vii). The loss function comprises a second component as a regularization term for penalizing overly confident prediction values in the predicted defect map, thus guiding the detection network to make reliable prediction.

(viii). The detection network, upon being trained, is used for single-image defect detection in runtime without reference image acquisition.

(ix). The defect map is usable as label data of the runtime image. The processing circuitry is further configured to include the runtime image and the defect map in a new training set, and using the new training set to train a supervised detection network.

In accordance with other aspects of the presently disclosed subject matter, there is provided a computerized method of runtime defect detection in a semiconductor specimen, the method comprising: obtaining a runtime image of the specimen; and processing, by a detection network, the runtime image to obtain a defect map indicating probabilities of defect distribution thereof. The detection network is previously trained unsupervised in a training phase, comprising, for a training image: obtaining a reference image of the training image; processing, by a detection network to be trained, the training image to generate a predicted defect map thereof; and optimizing the detection network to be trained using a loss function constructed based on the predicted defect map and a difference image between the training image and the reference image.

In accordance with other aspects of the presently disclosed subject matter, there is provided a computerized method of training a detection network usable for defect detection in a semiconductor specimen, the method comprising: obtaining a plurality of training images of a training specimen without ground truth label data thereof; for each given training image, obtaining a reference image thereof; processing, by the detection network, the given training image to obtain a predicted defect map indicating probabilities of defect distribution thereof; and optimizing the detection network using a loss function constructed based on the predicted defect map and a difference image between the training image and the reference image.

These aspects of the disclosed subject matter can comprise one or more of features (i) to (ix) listed above with respect to the system, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform any of the above listed methods.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a generalized flowchart of runtime defect detection for a semiconductor specimen in accordance with certain embodiments of the presently disclosed subject matter.

FIG. 3 illustrates a generalized flowchart of training a detection network in an unsupervised manner in accordance with certain embodiments of the presently disclosed subject matter.

FIG. 4 illustrates a generalized flowchart of a two-step training process in accordance with certain embodiments of the presently disclosed subject matter.

FIG. 5 illustrates a generalized flowchart of using the defect map as label data for self-supervised learning in accordance with certain embodiments of the presently disclosed subject matter.

FIG. 6 is a schematic illustration of an exemplary training process of the reconstruction network in accordance with certain embodiments of the presently disclosed subject matter.

FIG. 7 shows a schematic illustration of an exemplary inference deployment of the trained reconstruction network in accordance with certain embodiments of the presently disclosed subject matter.

FIG. 8 shows a schematic illustration of the second training step in the training process as described above with reference to FIGS. 3 and 4 in accordance with certain embodiments of the presently disclosed subject matter.

FIG. 9 shows a schematic illustration of runtime employment of the detection network in accordance with certain embodiments of the presently disclosed subject matter.

### DETAILED DESCRIPTION OF EMBODIMENTS

The process of semiconductor manufacturing often requires multiple sequential processing steps and/or layers, some of which could possibly cause errors that may lead to yield loss. Examples of various processing steps can include lithography, etching, depositing, planarization, growth (such as, e.g., epitaxial growth), and implantation, etc. Various examination operations, such as defect-related examination (e.g., defect detection, defect review, and defect classification, etc.), and/or metrology-related examination (e.g., critical dimension (CD) measurements, etc.), can be performed at different processing steps/layers during the manufacturing process to monitor and control the process. The examination operations can be performed a multiplicity of times, for example after certain processing steps, and/or after the manufacturing of certain layers, or the like.

Defect-related examination (also referred to herein as defect examination) can generally employ a two-phase procedure, e.g., inspection of a specimen, followed by review of sampled locations of potential defects. During the first phase, the surface of a specimen is inspected by an inspection tool at relatively higher speed and lower resolution. Defect detection is typically performed by applying a defect detection algorithm to the inspection output. Various detection algorithms can be used for detecting defects on specimens, such as die-to-reference (D2R) (e.g., Die-to-Die (D2D)), Die-to-History (D2H), Die-to-Database (D2DB), and Cell-to-Cell (C2C), etc. A defect map is produced to show suspected locations on the specimen having high probability of a defect.

During the second phase, at least some of the suspected locations on the defect map are more thoroughly analyzed by a review tool with relatively higher resolution, for ascertaining whether a defect candidate is indeed a DOI, and/or determining different parameters of the DOIs, such as classes, thickness, roughness, size, and so on. The D2R methodology as described above can be similarly applied during the second phase, such as, e.g., in automatic defect review (ADR) systems.

In some cases, machine learning (ML) technologies can be used to assist the defect examination process so as to provide accurate and efficient solutions for automating specific examination applications and promoting higher yield. For the purpose of providing a well-trained, accurate ML model that is robust with respect to various variations in actual production, training images must be sufficient in terms of quantity, quality and variance, etc., and the images need to be annotated with accurate labels in cases of supervised learning.

However, in many cases, collecting such comprehensive and annotated training data poses significant challenges. By way of example, obtaining labeled data for true defects is particularly difficult because true defects are often rare and difficult to detect, necessitating human annotation. This manual annotation process is typically time-consuming, labor-intensive, and prone to errors. In addition, the variability in human annotation may introduce inconsistencies in the training data, reducing the robustness and generalizability of the trained model across different production environments and defect types.

Inaccurate labeling can mislead the machine learning model, causing it to fail in identifying actual defects of interest (DOIs) or misclassify defects during runtime. These inaccuracies can severely impact the performance of ML-based defect detection systems, leading to false positives, where non-defective areas are incorrectly flagged as defective, and false negatives, where actual defects are missed. Both scenarios can result in yield loss and increased manufacturing costs. Consequently, there is a need for innovative approaches that can reduce or eliminate the dependence on human-labeled data while maintaining high accuracy and reliability in defect detection.

Accordingly, certain embodiments of the presently disclosed subject matter address the above issues by providing an end-to-end method for automatic defect detection in semiconductor specimens without the need for human-labeled data. Certain embodiments of the proposed solution employ a dual-network approach involving a reconstruction network and a detection network. The reconstruction network is trained to generate a clean reference image from a defect image. This network, once trained, is used to generate reference images for defect images during the training of the detection network. The detection network is trained without human-labeled data by using a specially designed loss function that combines a difference image (between the defect image and the generated reference image) with a predicted defect map, as will be detailed below.

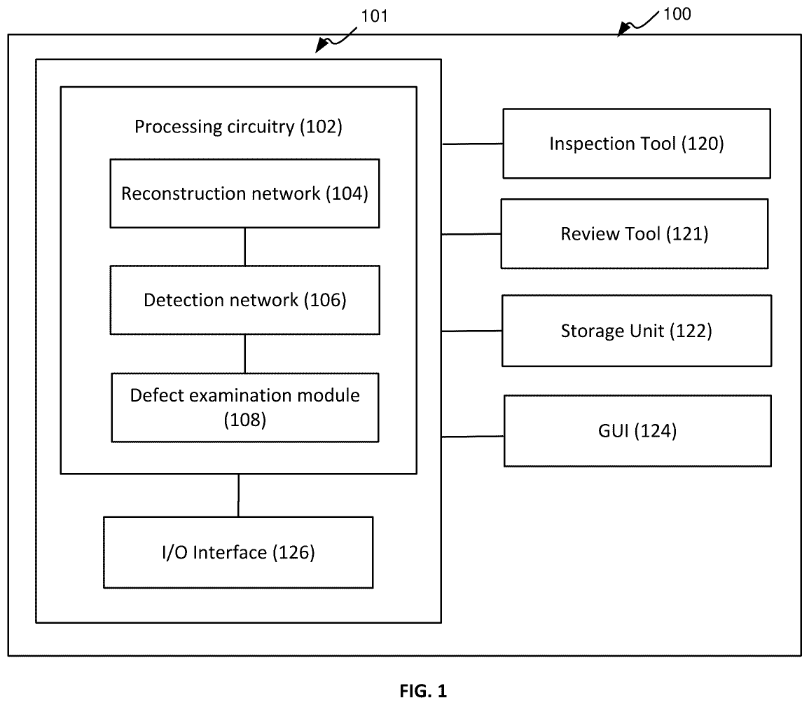

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of a semiconductor specimen (e.g., a wafer, a die, or parts thereof) as part of the specimen fabrication process. As described above, the examination referred to herein can be construed to cover any kind of operations related to defect inspection/detection, defect review, defect classification, nuisance filtration, segmentation, and/or metrology operations, such as, e.g., critical dimension (CD) measurements, etc., with respect to the specimen. System 100 comprises one or more examination tools configured to scan a specimen and capture images thereof to be further processed for various examination applications.

The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the specimen or parts thereof. Without limiting the scope of the disclosure in any way, it should also be noted that the examination tools can be implemented as inspection machines of various types, such as optical inspection machines, electron beam inspection machines (e.g., a Scanning Electron Microscope (SEM), an Atomic Force Microscopy (AFM), or a Transmission Electron Microscope (TEM), etc.), and so on.

The one or more examination tools can include one or more inspection tools 120 and one or more review tools 121. In some cases, an inspection tool 120 can be configured to scan a specimen (e.g., an entire wafer, an entire die, or portions thereof) to capture inspection images (typically, at a relatively high-speed and/or low-resolution) for detection of potential defects (i.e., defect candidates). During inspection, the wafer can move at a step size relative to the detector of the inspection tool (or the wafer and the tool can move in opposite directions relative to each other) during the exposure, and the wafer can be scanned step-by-step along swaths of the wafer by the inspection tool, where the inspection tool images a part/portion (within a swath) of the specimen at a time. By way of example, the inspection tool can be an optical inspection tool. At each step, light can be detected from a rectangular portion of the wafer and such detected light is converted into multiple intensity values at multiple points in the portion, thereby forming an image corresponding to the part/portion of the wafer. For instance, in optical inspection, an array of parallel laser beams can scan the surface of a wafer along the swaths. The swaths are laid down in parallel rows/columns contiguous to one another, to build up, swath-at-a-time, an image of the surface of the wafer. For instance, the tool can scan a wafer along a swath from up to down, then switch to the next swath and scan it from down to up, and so on and so forth, until the entire wafer is scanned and inspection images of the wafer are collected.

In some cases, a review tool 121 can be configured to capture review images of at least some of the defect candidates detected by inspection tools for ascertaining whether a defect candidate is indeed a defect of interest (DOI). Such a review tool is usually configured to inspect fragments of a specimen, one at a time (typically, at a relatively low-speed and/or high-resolution). By way of example, the review tool can be an electron beam tool, such as, e.g., a scanning electron microscope (SEM), etc. An SEM is a type of electron microscope that produces images of a specimen by scanning the specimen with a focused beam of electrons. The electrons interact with atoms in the specimen, producing various signals that contain information on the surface topography and/or composition of the specimen. An SEM is capable of accurately inspecting and measuring features during the manufacture of semiconductor wafers.

The inspection tool 120 and review tool 121 can be different tools located at the same or at different locations, or a single tool operated in two different modes. In some cases, the same examination tool can provide low-resolution image data and high-resolution image data. The resulting image data (low-resolution image data and/or high-resolution image data) can be transmitted-directly or via one or more intermediate systems—to system 101. The present disclosure is not limited to any specific type of examination tools and/or the resolution of image data resulting from the examination tools. In some cases, at least one of the examination tools has metrology capabilities and can be configured to capture images and perform metrology operations on the captured images. Such an examination tool is also referred to as a metrology tool.

According to certain embodiments of the presently disclosed subject matter, the examination system 100 comprises a computer-based system 101 operatively connected to the inspection tool 120 and/or the review tool 121, and capable of ML-based defect detection in semiconductor specimens. System 101 is also referred to as a defect detection system.

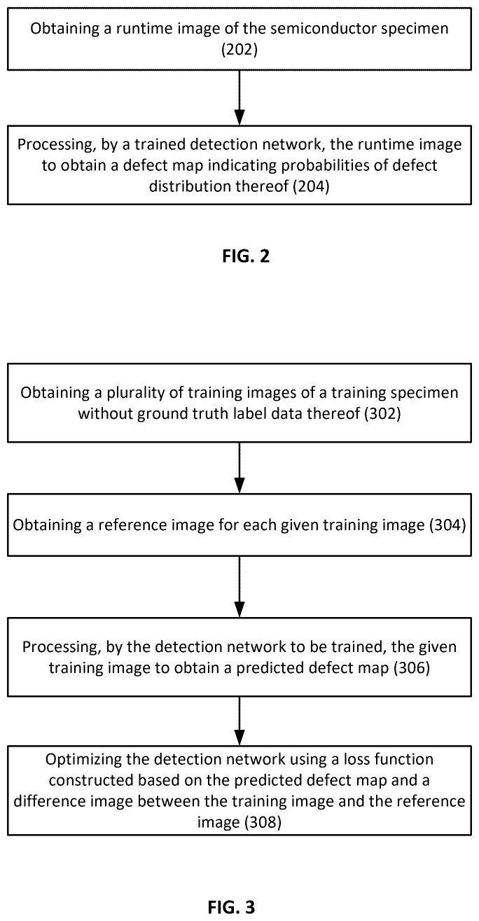

System 101 includes a processing circuitry 102 operatively connected to a hardware-based I/O interface 126 and configured to provide processing necessary for operating the system, as further detailed with reference to FIGS. 2-5. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

According to certain embodiments, system 101 can be configured as a runtime defect detection system. In such cases, one or more functional modules comprised in the processing circuitry 102 of system 101 can include a trained detection network 106. In some cases, the processing circuitry 102 can further comprise a defect examination module 108 operatively connected to the detection network 106. The detection network 106 was previously trained during a training/setup phase.

Specifically, the processing circuitry 102 can be configured to obtain, via an I/O interface 126, a runtime image of a semiconductor specimen, and process the runtime image by the trained detection network 106, to obtain a defect map indicating probabilities of defect distribution thereof. The detection network 106 has been previously trained unsupervised in a training phase (without label data). The trained detection network is used for single-image detection in runtime. Optionally, the defect map can be provided to the defect examination module 108 for further processing and examination.

In some cases, the detection network 106 and the optional defect examination module 108 can be regarded as part of an examination recipe usable for performing runtime examination operations for semiconductor specimens, including defect detection, defect review/classification, etc., on various runtime images acquired for a specimen to be examined.

In some embodiments, system 101 can be configured as a training system capable of training the detection network 106 during a training/setup phase. In such cases, one or more functional modules comprised in the processing circuitry 102 of system 101 can include a training module (not illustrated in the figure), and a reconstruction network 104 and the detection network 106 to be trained (i.e., the initially constructed model that is not yet trained). Specifically, the training module can be configured to obtain a specific training set, and use the training set to train the detection network 106. In some cases, the training module can be configured to train the reconstruction network 104, prior to training the detection network 106, as will be detailed below.

According to certain embodiments, the reconstruction network and/or the detection network (although termed as networks) can be implemented as various types of ML models, such as, e.g., decision tree, Support Vector Machine (SVM), Artificial Neural Network (ANN), regression model, Bayesian network, or ensembles/combinations thereof etc. The learning algorithms used by the networks can be any of the following: supervised learning, unsupervised learning, self-supervised, semi-supervised learning, or a combination thereof, etc. The presently disclosed subject matter is not limited to the specific types of the networks or the specific types of learning algorithms used by the networks.

By way of example, in some cases, the networks can be implemented as a deep neural network (DNN). DNN can comprise multiple layers organized in accordance with respective DNN architecture. By way of non-limiting example, the layers of DNN can be organized in accordance with architecture of a Convolutional Neural Network (CNN), Recurrent Neural Network, Recursive Neural Networks, autoencoder, Generative Adversarial Network (GAN), or otherwise. Optionally, at least some of the layers can be organized into a plurality of DNN sub-networks. Each layer of DNN can include multiple basic computational elements (CE) typically referred to in the art as dimensions, neurons, or nodes.

The weighting and/or threshold values associated with the CEs of a DNN and the connections thereof can be initially selected prior to training, and can be further iteratively adjusted or modified during training to achieve an optimal set of weighting and/or threshold values in a trained DNN. After each iteration, a difference can be determined between the actual output produced by DNN module and the target output associated with the respective training set of data. The difference can be referred to as an error value. Training can be determined to be complete when a loss/cost function indicative of the error value is less than a predetermined value, or when a limited change in performance between iterations is achieved. A set of input data used to adjust the weights/thresholds of a DNN is referred to as a training set.

It is to be noted that the teachings of the presently disclosed subject matter are not bound by the specific architecture of the networks as described above.

It is to be noted that while certain embodiments of the present disclosure refer to the processing circuitry 102 being configured to perform the above recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules, such as the network processing, and defect examination, etc., can thus be performed by respective processors (or processor combinations) in the processing circuitry 102, while, optionally, these operations may be performed by the same processor. The present disclosure should not be limited to being construed as one single processor always performing all the operations.

In some cases, additionally to system 101, the examination system 100 can comprise one or more examination modules, such as, e.g., defect detection module, nuisance filtration module, Automatic Defect Review Module (ADR), Automatic Defect Classification Module (ADC), metrology operation module, and/or other examination modules which are usable for examination of a semiconductor specimen. The one or more examination modules can be implemented as stand-alone computers, or their functionalities (or at least part thereof) can be integrated with the examination tools 120 and 121. In some cases, the output of system 101, e.g., the defect map, and the defect examination result, can be provided to the one or more examination modules (such as the ADR, ADC, etc.) for further processing. In some cases, the functional modules 106 and/or 108 can be comprised in the one or more examination modules for the purpose of defect detection. Optionally, these functional modules can be shared between the examination modules or, alternatively, each of the one or more examination modules can comprise its own functional modules.

According to certain embodiments, system 100 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store images of the specimen and/or derivatives thereof produced by the examination tool 120, such as, e.g., the runtime images, reference images, and the training set, as described above. Accordingly, the different types of input data as required can be retrieved from the storage unit 122 and provided to the processing circuitry 102 for further processing. The output of the system 101, such as, e.g., the defect map, and the defect examination result, etc., can be sent to storage unit 122 to be stored.

In some embodiments, system 100 can optionally comprise a computer-based Graphical User Interface (GUI) 124 which is configured to enable user-specified inputs related to system 101. For instance, the user can be presented with a visual representation of the specimen (for example, by a display forming part of GUI 124), including the images of the specimen, the defect maps, etc. The user may be provided, through the GUI, with options of defining certain operation parameters. The user may also view the operation results or intermediate processing results, such as, e.g., the defect map, and the defect examination result, etc., on the GUI.

In some cases, system 101 can be further configured to send, via I/O interface 126, the operation results to the examination tools 120 and 121 for further processing. In some cases, system 101 can be further configured to send the results to the storage unit 122, and/or external systems (e.g., Yield Management System (YMS) of a fabrication plant (fab)). A yield management system (YMS) in the context of semiconductor manufacturing is a data management, analysis, and tool system that collects data from the fab, especially during manufacturing ramp ups, and helps engineers find ways to improve yield. YMS helps semiconductor manufacturers and fabs manage high volumes of production analysis with fewer engineers. These systems analyze the yield data and generate reports. YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It should be noted that the examination system illustrated in FIG. 1 can be implemented in a distributed computing environment, in which one or more of the aforementioned components and functional modules shown in FIG. 1 can be distributed over several local and/or remote devices. By way of example, the examination tools 120 and 121, and the system 101, can be located at the same entity (in some cases hosted by the same device) or distributed over different entities. By way of another example, as described above, in some cases, system 101 can be configured as a training system for training the networks, while in some other cases, system 101 can be configured as a runtime detection system using the trained networks. The training system and the runtime system can be located at the same entity (in some cases hosted by the same device), or distributed over different entities, depending on specific system configurations and implementation needs.

In some examples, certain components utilize a cloud implementation, e.g., are implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

It should be further noted that in some embodiments at least some of examination tools 120 and 121, storage unit 122 and/or GUI 124 can be external to the examination system 100 and operate in data communication with systems 100 and 101 via I/O interface 126. System 101 can be implemented as stand-alone computer(s) to be used in conjunction with the examination tools, and/or with the additional examination modules as described above. Alternatively, the respective functions of the system 101 can, at least partly, be integrated with one or more examination tools 120 and 121, thereby facilitating and enhancing the functionalities of the examination tools in examination-related processes.

While not necessarily so, the process of operations of systems 101 and 100 can correspond to some or all of the stages of the methods described with respect to FIGS. 2-5. Likewise, the methods described with respect to FIGS. 2-5 and their possible implementations can be implemented by systems 101 and 100. It is therefore noted that embodiments discussed in relation to the methods described with respect to FIGS. 2-5 can also be implemented, mutatis mutandis as various embodiments of the systems 101 and 100, and vice versa.

Referring to FIG. 2, there is illustrated a generalized flowchart of runtime defect detection for a semiconductor specimen in accordance with certain embodiments of the presently disclosed subject matter.

As described above, a semiconductor specimen is typically made of multiple layers. The examination process of a specimen can be performed a multiplicity of times during the fabrication process of the specimen, for example following the processing steps of specific layers. In some cases, a sampled set of processing steps can be selected for in-line examination, based on their known impacts on device characteristics or yield. Images of the specimen or parts thereof can be acquired at the sampled set of processing steps to be examined.

For the purpose of illustration only, certain embodiments of the following description are described with respect to images of a given processing step/layer of the sampled set of processing steps. Those skilled in the art will readily appreciate that the teachings of the presently disclosed subject matter can be performed following any layer and/or processing steps of the specimen. The present disclosure should not be limited to the number of layers comprised in the specimen and/or the specific layer(s) to be examined.

A runtime image of a semiconductor specimen can be obtained (202) (e.g., by the processing circuitry 102 from the inspection tool 120 or the review tool 121) during runtime examination of the specimen.

The runtime image refers to an image that is actually acquired by an inspection tool or a review tool as described above, or any derivatives of the actually acquired image (such as resulting from any pre-processing of the acquired image). For instance, a runtime image can be an optical image acquired by an optical inspection tool, or an electron beam (e-beam) image acquired by an electron beam tool during in-line examination of the specimen, depending on the specific examination modality thereof. A semiconductor specimen here can refer to a semiconductor wafer, a die, or parts thereof, that is fabricated and examined in the fab during a fabrication process thereof. A runtime image refers to an image capturing at least part of the specimen. By way of example, an image can capture a region or a structure that is of interest to be examined on the specimen.

The runtime image can be processed (204) by a trained detection network (e.g., the detection network 106), to obtain a defect map indicating probabilities of defect distribution thereof. The detection network referred to in block 204 is a pre-trained model that has been previously trained under unsupervised learning (without any label data) in a training phase for defect detection.

The term “label data” or “labeled data” used herein refers to training data that has been annotated with additional information to indicate the presence, absence, or characteristics of certain features such as defects within the training data. Specifically, for defect detection in semiconductor specimens, label data may typically refer to labels associated with each training image in a training set, identifying the locations, types, and possibly other properties of defects in the training image. Each training image in the training set is tagged with such labels, which are usually created through human annotation, where experts review the training image and provide accurate labels to guide the training of machine learning models. The label data is typically used as ground truth defect information for the training images in supervised learning, where ML models learn to predict outcomes based on the provided labels.

In contrast, under unsupervised learning, the ML model is trained without any explicit label data or supervision, therefore saving the time and efforts of human annotation. In unsupervised learning, the model must learn to infer patterns, structures, or relationships within the training data on its own, without the guidance provided by labeled data, which in some cases may lead to less precise outcomes. The present disclosure proposes a unique training method enabling the detection network to still be able to accurately identify defects without presence of label data.

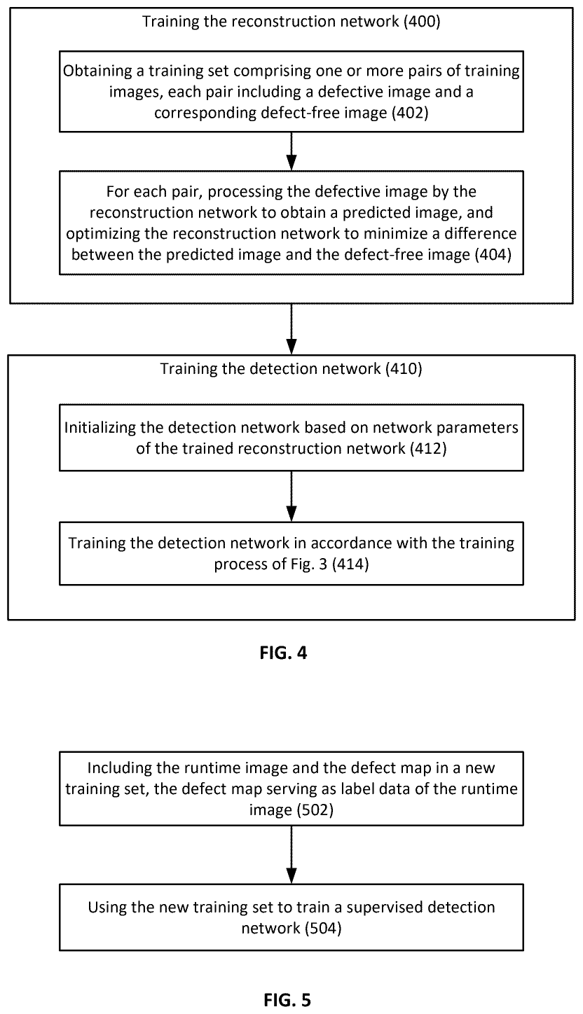

Referring now to FIG. 3, there is illustrated a generalized flowchart of training a detection network in an unsupervised manner in accordance with certain embodiments of the presently disclosed subject matter.

A plurality of training images of a training specimen can be obtained (302) (e.g., by a training module when system 101 is configured as a training system). The training images can be “real world” images (i.e., actual images) of the training specimen acquired by an examination tool. In some cases, at least some training images may be simulated images. The plurality of training images are not associated with any ground truth label data thereof. In other words, the training images are not manually annotated to indicate the presence of defects thereof.

For each given training image in the plurality of training images, a reference image of the given training image can be obtained (304). A reference image refers to a nominal image or a defect-free image that captures the same/similar structural features as a target image (e.g., the given training image) and is used as a reference for comparison with the target image. The reference image is typically a clean image, free of defective features, or has a high probability of not comprising any defective features.

In some embodiments, the reference image of a given training image can be an actual image acquired by an examination tool. By way of example, the reference image can be acquired from a reference region of the target region captured by the given training image. For instance, in D2D inspection, the reference image can be acquired from a corresponding region of a neighboring die.

In some other embodiments, the reference image can be synthetically generated by a reconstruction network, which has been previously trained for image reconstruction. For instance, the given training image can be fed as input to the reconstruction network to be processed, which will generate a synthetic reference image of the training image as output, as will be detailed below with reference to FIGS. 4, 6, and 7.

The given training image can be processed (306) by the detection network to be trained (i.e., the untrained detection network), to generate a predicted defect map thereof. A defect map, also referred to as a defect segmentation map, represents defect spatial distribution in the corresponding image of the examined specimen (e.g., the presence, location, and possibly the probabilities of defects within the examined specimen). For instance, each pixel or region in the defect map corresponds to a specific area of the specimen, and the pixel values in the map signify the likelihood of defect presence in those areas. The defect map can be a binary map, where each pixel is indicated as either defect or non-defect, or a probability map, where each pixel has a value representing the probability or confidence level of a defect being present at the corresponding location.

The detection network to be trained can be optimized (308) using a loss function specifically constructed based on the predicted defect map, and a difference image between the given training image and the reference image. By way of example, the given training image and the reference image can be aligned and compared to each other. The difference image can be generated by calculating the pixel-wise difference between the aligned given training image and the reference image. Each pixel in the difference image represents the magnitude of the difference at that location, with higher values indicating greater discrepancies. In some cases, a normalization factor may be possibly applied to the difference image to provide a normalized difference image.

The present disclosure proposes a novel loss function used to train the detection network, enabling it to accurately identify defects without ground truth label data. The loss function is designed to combine the predicted defect map and the difference image. The difference image, generated by calculating the pixel-wise difference between a defect image and a reference image, can serve as a “surrogate” guide in the absence of label data. By integrating the predicted defect map with the difference image, the loss function aligns the predicted defect map with regions of potential defects indicated by the difference image. This approach leverages the information embedded in the difference image to provide implicit guidance during the training process. As a result, the detection network can learn to emphasize/focus on areas that correlate with significant discrepancies/differences, which are likely to correspond to defects, thereby improving the accuracy and reliability of defect detection even without explicit ground truth labels.

In some embodiments, the loss function can include a first component that is calculated using a combination of the predicted defect map and the difference image, either through their product or ratio. This component plays an essential role in guiding the training process by aligning the predicted defect map with potential defects indicated by the difference image, thus emphasizing regions in the predicted defect map that correlate with significant differences in the difference image. Using the combination of the two, either by the product or the ratio, can enable to highlight areas where the predicted defects correspond to pronounced discrepancies, and to balance the defect map against the intensity of the differences.

In this context, the predicted defect map can be regarded as a confidence map comprising confidence scores that represent how confident the detection network is about the presence of defects. These confidence scores indicate the likelihood of defect presence, influenced by the quality of the difference image (which in turn depends on the quality of the generated reference image when a reconstruction network is used). By incorporating these confidence scores into the loss function, the training process, sometimes referred to as confidence learning, not only aligns the defect map with actual defects, but also adjusts the network's focus based on the confidence levels. This results in improved accuracy and robustness of defect detection without the need for labeled data, as the network learns to prioritize regions with higher confidence scores, effectively simulating supervised learning conditions.

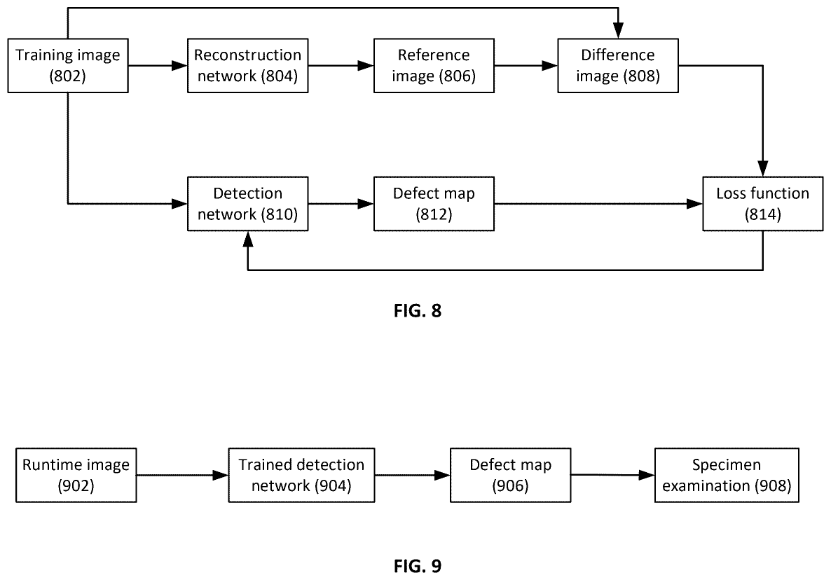

In some embodiments, the loss function can include a second component as a regularization term for penalizing overly confident prediction values in the predicted defect map, thus guiding the detection network to make reliable prediction, as will be exemplified below with reference to FIG. 8.

As described above, in some cases, the reference image can be a synthetic image generated using a reconstruction network. The reconstruction network can be previously trained for reference generation (i.e., generating reference images for examination images acquired in runtime), where the input image to the network is an original image of the semiconductor specimen that is actually acquired by an examination tool (e.g., by the inspection tool 120 or the review tool 121 as described above), or any derivatives of the original image (such as resulting from any pre-processing of the original image), and the generated image is a reconstructed synthetic reference image that is expected to be defect-free and usable for comparison with the original image for the purpose of defect detection in the original image.

It should be noted that the terms “original images”, “actual images” or “images actually acquired” used herein refer to real images that are directly obtained from an examination tool during the inspection or review process. These images are captured by devices such as optical inspection tools, electron beam tools, or other similar examination equipment, and represent the true visual data of the semiconductor specimen at the time of acquisition. On the other hand, the terms “synthetic images,” “reconstructed images,” or “simulated images” used herein refer to images that are artificially generated, typically using machine learning models such as the reconstruction network mentioned above. These generated images are produced through computational methods and are intended to replicate the actual images for various purposes, such as defect detection or image simulation.

The reconstruction network is also referred to as a generative model, which is trained to learn to generate new data instances. In some embodiments, the reconstruction network is trained prior to training of the detection network. In such cases, the training process can comprise two steps: the first training step, where the reconstruction network is trained, and the second training step where the detection network is trained using the trained reconstruction network.

FIG. 4 illustrates a generalized flowchart of a two-step training process in accordance with certain embodiments of the presently disclosed subject matter.

In the first step 400 of the training process, the reconstruction network can be firstly trained. The reconstruction network can be trained in different manners using supervised learning or unsupervised learning.

By way of example, in some cases the reconstruction network can be trained using supervised learning. For instance, a training set comprising one or more pairs of training images of the training specimen can be obtained (402), each pair including a defective image and a corresponding reference image. The reconstruction network can be trained using supervised learning based on the training set.

A defective image used herein refers to an image that comprises, or has a high probability of comprising, defective features representative of actual defects on a specimen. The reference image corresponds to the defective image in a sense that it captures a similar region containing similar patterns as of the defective image. The reference image serves as the ground truth data associated with the defective image in the same pair. The reconstruction network is trained to learn the non-linear mapping relationship between the two populations of defective images and reference images.

The training of the reconstruction network can comprise, for each pair of the one or more pairs of training images, processing (404) the defective image by the reconstruction network to obtain a predicted image, and optimizing the reconstruction network to minimize a difference between the predicted image and the reference image. In some cases, the defective image and the reference image in each pair can be pre-processed before being fed to the ML model for training the model for the purpose of reducing the impacts of variations, such as process variations, gray level variations, etc., which are caused by certain physical processes of the specimens. The pre-processing can comprise one or more of the following operations: image registration, noise filtration, and image augmentation.

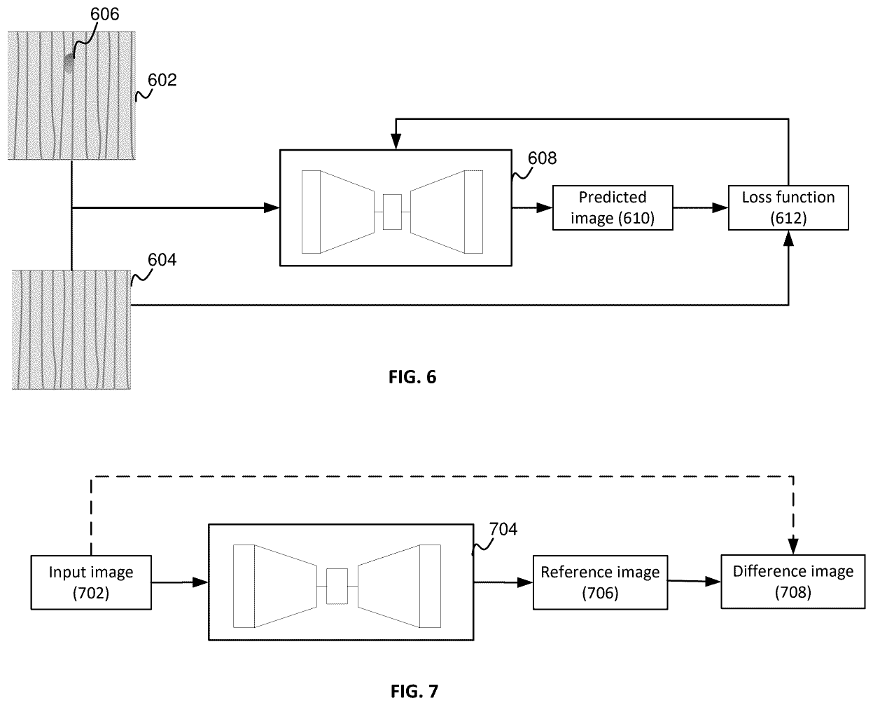

FIG. 6 shows a schematic illustration of an exemplary training process of the reconstruction network in accordance with certain embodiments of the presently disclosed subject matter.

A pair of training images including a defective image 602 and a defect-free image 604 are exemplified. As shown, the defective image 602 comprises a defective feature 606 (such as, e.g., a bridge formed between two line structures). The defect-free image 604 corresponds to the defective image 602 (e.g., it captures an area having similar patterns as of the defective image), and does not comprise any defective feature. In some cases, optionally, the defective image and the defect-free image in each pair can be pre-processed (e.g., including image registration, noise filtration, and image augmentation) before being fed to the reconstruction network for training the model.

The defective image is fed into the reconstruction network 608 to be processed. The output of the reconstruction network 608 is a predicted image 610. The predicted image 610 is evaluated with respect to the defect-free image 604 (which serves as ground truth data for the predicted image) using a loss function 612 (also referred to as cost function). The loss function 612 can be a difference metric configured to represent a difference between the predicted image and the defect-free image. The reconstruction network 608 can be optimized by minimizing the value of the loss function 612. By way of example, the reconstruction network 608 can be optimized using a loss function such as, e.g., Mean squared error (MSE), Sum of absolute difference (SAD), structural similarity index measure (SSIM), or an edge-preserving loss function. It is to be noted that the term “minimize” or “minimizing” used herein refers to an attempt to reduce a difference value represented by the loss function to a certain level/extent (which can be predefined), but not necessarily have to reach the actual minimum.

In some other cases, alternatively, the reconstruction network can be possibly trained using unsupervised learning based on a training set of nominal images of one or more training specimens. A nominal image is also referred to as a defect-free image. As described above, it is a clean image, free of defective features, or has a high probability of not comprising any defective features. The training set of nominal images can be collected from “real-world”/actual images of the training specimens, or, alternatively, at least part of the images can be simulated, based on design data of the specimens.

By way of example, the reconstruction network can be implemented as an autoencoder (AE) or variations thereof (e.g., VAE). Autoencoder is a type of neural network commonly used for the purpose of data reproduction by learning efficient data coding and reconstructing its inputs (e.g., minimizing the difference between the input and the output).

For each input nominal image in the training set, the autoencoder can extract features representative of the input image, and use the representative features to reconstruct a corresponding output image which can be evaluated by comparing with the input image. The autoencoder is trained and optimized so as to learn the representative features in the input training images (e.g., the features can be representative of, e.g., structural elements, patterns, pixel distribution, etc., in the training images). As the training images are nominal images, the autoencoder is trained to learn the distribution of normal patterns and characteristics of defect-free images.

Once the autoencoder is trained based on the training set, the trained autoencoder is capable of generating, for each input image, a reconstructed output image that closely matches the input, based on the latent representation thereof. As the autoencoder is trained with only nominal images, it will not be able to reconstruct anomaly patterns (defective patterns) that were not observed during training. In cases where the input image is a defective image, the autoencoder will reconstruct a corresponding defect-free image of the defective image. Therefore, the trained autoencoder can be used for generating a synthetic reference image for a given real/actual image of a specimen which is actually acquired by an examination tool.

Upon being trained (either supervised or unsupervised), the reconstruction network can be used in inference, e.g., for runtime examination, or for assisting in training the detection network in the second step of the training process. FIG. 7 shows a schematic illustration of an exemplary inference deployment of the trained reconstruction network in accordance with certain embodiments of the presently disclosed subject matter. An input image 702 (e.g., a runtime image to be examined, or a training image for training the detection network) is fed into a trained reconstruction network 704 to be processed. The reconstruction network 704 has been previously trained as described above. Upon processing the image 702, the reconstruction network 704 provides a synthetic reference image 706 as an output. The input image 702 and the reference image 706 can be compared to generate a difference image 708.

Continuing with the description of FIG. 4, upon the reconstruction network being trained in the first training step 400, the reconstruction network can be “frozen”, i.e., the network parameters are fixed and are no longer adjusted. The trained reconstruction network can be used to train the detection network in the second training step 410.

In some cases, the detection network can be initialized (412) based on the network parameters of the trained reconstruction network. By way of example, the detection network can be initialized by duplicating or copying the network parameters from the trained reconstruction network. That is to say, the initial weights and biases of the detection network are set to be the same as those of the trained reconstruction network.

Such initialization can provide a beneficial starting point for the detection network, as the reconstruction network has already been trained to generate clean reference images from defective images, meaning it has learned to capture and represent important features and patterns in the defect images. By using these learned features as a starting point, the detection network can inherit a rich set of representations that are relevant to the task of defect detection. In addition, the transfer of knowledge from the reconstruction network can significantly speed up the training process of the detection network. By initializing with the pre-trained parameters, the detection network can converge more quickly, as it starts with a set of weights that already encode useful information on the data, as compared to training the network from scratch, which typically requires a large amount of data and computational resources to converge to an optimal solution.

The detection network initialized as such can be trained (414) in accordance with the training flow described above with reference to FIG. 3.

In some cases, the training of the reconstruction network and/or the detection network (as described in FIG. 3) can be iteratively performed, where the model parameters are iteratively adjusted using optimization algorithms to minimize the loss function. For instance, the optimization process may involve computing the gradient of the loss function with respect to the model parameters, and updating the parameters in the direction that reduces the loss. This iterative training may continue until a predefined criterion is met, such as, e.g., a specified number of epochs, convergence of the loss function, or achieving a minimum loss, etc. Early stopping can also be employed in some cases, where training is halted if the loss does not improve for a set number of consecutive epochs, preventing overfitting and ensuring the model generalizes well to new data.

Turning now to FIG. 8, there is a schematic illustration of the second training step in the training process as described above with reference to FIGS. 3 and 4 in accordance with certain embodiments of the presently disclosed subject matter.

A training image 802 is provided as input to the reconstruction network 804 which has been previously trained. Upon processing the input training image, the reconstruction network 804 outputs a synthetic reference image 806. A difference image 808 is computed by comparison between the training image 802 and the reference image 806.

In parallel, the training image 802 is fed as input to an untrained detection network 810. The detection network 810 processes the training image 802 and outputs a predicted defect map 812 indicative of defect distribution (e.g., spatial distribution) in the training image 802. A loss function 814 can be constructed by combining the difference image 808 and the predicted defect map 812. For instance, the loss function 814 can be designed to comprise a first component calculated as a product or ratio between the difference image and the defect map. In some cases, the loss function can further comprise a second component as a regularization term for penalizing overly confident prediction values in the predicted defect map, thus guiding the detection network to make reliable prediction. The detection network 810 can be optimized iteratively to minimize the value of the loss function 814.

By way of example, the loss function 814 of the detection network 810 can be designed as follows:

$$Loss = E [ {L}_{D} / c ( x ) ] + E [ log ( c ( x ) ) ]$$

where L_{D}=|D−\hat{R}|, D represents the training image, \hat{R} represents to the generated reference image, L_{D} represents the difference image, and c(x) represents the defect map.

In the above example of loss function, E[L_{D}/c(x)] represents the first component, which is calculated as the ratio between the difference image and the predicted defect map. E[log(c(x)) represents the second component which serves as the regularization term.

The first component ensures that the network focuses on regions where the difference image L_{D} indicates a significant likelihood of defects. For the purpose of illustration, consider a scenario where a pixel value in the difference image L_{D} indicates a significant difference, thus suggesting a high likelihood of presence of a defect. In such cases, c(x), which is the predicted defect map, should also provide a prediction with higher value, so as to minimize the value of the first component in the loss function. Specifically, if L_{D} is high, indicating a likely defect, then c(x) should also be high for the same pixel, resulting in a lower ratio L_{D}/c(x). This drives the network to align the defect map with the areas of significant differences indicated by the difference image, effectively guiding the detection network to focus on potential defect regions.

As described above, confidence learning refers to the process by which the detection network is guided to make reliable predictions with high confidence by incorporating confidence scores into the training process. These confidence scores are derived from the defect map c(x), which represents the predicted likelihood of defects at various locations in the runtime image. In this exemplary loss function, the first component ensures that the network focuses on regions where the difference image L_{D} indicates a significant likelihood of defects. For a pixel where L_{D} is high, indicating a potential defect, the value of c(x) should also be high to minimize the ratio L_{D}/c(x). Higher values in the defect map c(x) correspond to higher confidence scores, indicating that the network is more certain/confident about the presence of a defect in those regions.

Confidence learning is used to balance the network's predictions. Without additional regulation, the detection network might attempt to assign high confidence scores across all locations in the defect map to minimize the loss function, leading to overconfident and indiscriminate predictions (e.g., causing a defect map where all regions are predicted as defects, reducing the reliability and accuracy of the defect detection). This is where the second component of the loss function, E[log(c(x))], comes into play as a regularization term. The logarithmic function log (c(x)) in the second component heavily penalizes predictions where c(x) is excessively high across all locations (i.e., overly confident prediction values). By including this term, the loss function discourages the network from assigning uniformly high defect probabilities, thereby preventing overconfidence and ensuring that high confidence scores are assigned only where they are truly warranted (e.g., in regions where the difference image L_{D} indicates a high likelihood of defects). As a result, the network is guided to make more reliable predictions with higher confidence in regions where defects are likely present, and lower confidence elsewhere.

This balanced design of the loss, combining the ratio of the difference image and the defect map with the regularization term, enables the detection network to accurately and reliably identify defects. The first component ensures that the network focuses on regions with significant differences, while the second component prevents overconfident and widespread predictions, leading to a more precise and trustworthy defect detection system.

By way of another example, in some cases, the loss function 814 of the detection network 810 can be alternatively designed as below, where the first component is calculated as the product between the difference image and the predicted defect map:

$$Loss = E [ {L}_{D} * c ( x ) ] + E [ log ( 1 / c ( x ) ) ]$$

Upon the detection network being trained, the trained detection network can be used in runtime for defect detection. FIG. 9 is a schematic illustration of runtime employment of the detection network in accordance with certain embodiments of the presently disclosed subject matter.

A runtime image 902 of a specimen can be acquired during runtime examination. The runtime image 902 is fed as input to the trained detection network 904 to be processed. The detection network 904 has been trained unsupervised in accordance with the teachings with reference to FIGS. 2-4. As output, the detection network 904 provides a defect map 906 corresponding to the runtime image 902 and indicative of defect spatial distribution on the specimen, including, e.g., presence, location and possibly other defect properties of any detected defects thereof. In some cases, the defect map 906 can be used for further examination 908 of the specimen, such as ADR, ADC, etc.

It is to be noted that the detection network trained as such is usable for single-image detection. That is to say that the network only needs a single input of the runtime image, and there is no need to acquire a reference image for the runtime image. This capability of single-image detection is conferred by the training process of the detection network. The detection network has learned to identify and segment defects solely based on the patterns and features present in the defect images. During the training phase, the network was guided by the difference images generated by comparing defect images to reference images. This guidance enabled the detection network to learn to recognize intrinsic characteristics of defects without relying on external references during runtime. The incorporation of a loss function that combines the predicted defect map and the difference image ensures that the network can focus on areas with high likelihoods of defects, effectively enabling it to generalize from the training data to real-world scenarios where only the defect image is available.

The benefits of this single-image detection capability are manifold. Firstly, it simplifies the defect detection process by eliminating the need for acquiring reference images, which can be time-consuming and resource-intensive. This reduction in complexity streamlines the examination workflow, making it faster and more efficient. Secondly, it enhances the practicality of the defect detection system in environments where acquiring consistent and accurate reference images may be challenging or impractical, and also reduces the dependency on precise alignment between the defect image and the reference image.

In some embodiments, the defect map generated by the detection network can be used as label data for the corresponding runtime image. FIG. 5 illustrates a generalized flowchart of using the defect map as label data for self-supervised learning in accordance with certain embodiments of the presently disclosed subject matter.

A runtime image and its defect map generated by the trained detection network can be included (502) in a new training set, where the defect map serves as the ground truth label data of the runtime image. Similarly, additional runtime images of the specimen can be processed by the detection network, and the generated defect maps are used as respective label data for the corresponding runtime images. The training set can be prepared by including a plurality of runtime images and their defect maps generated by the detection network. The new training set can be used (504) to train a supervised detection network, i.e., a detection network that is trained under supervised learning, unlike the detection network 904 which is trained unsupervised.

The option of using the defect map generated by the detection network as label data for the corresponding runtime image enables the capability of self-supervised learning. In self-supervised learning, the model generates its own labels from the data, thereby creating a training set that can be used to further improve the model or train additional models under supervised learning paradigms. The self-generated labels are based on the network's deep understanding of defect patterns, resulting in a more precise and reliable training set. By including the labeled images in a new training set, a robust dataset is created that reflects the true characteristics of defects as detected by the detection network. This dataset can then be utilized to train a supervised detection network, leveraging the high-quality labels generated by the self-supervised process.

The self-supervised learning provides many benefits. It significantly reduces the need for manually labeled data, which is often a bottleneck in training machine learning models due to the time, cost, and potential errors involved in human annotation. By automatically generating labels, the system can continuously update and expand the training set with new data, ensuring that the detection network remains up-to-date with the latest patterns and variations in defect types. This ongoing learning process enables the system to adapt to changes in manufacturing processes without the need for extensive manual re-labeling efforts.

It is to be noted that examples illustrated in the present disclosure, such as, e.g., the exemplified networks and structures, the exemplary images and defects, the loss functions, the training datasets, etc., are illustrated for exemplary purposes, and should not be regarded as limiting the present disclosure in any way. Other appropriate examples/implementations can be used in addition to, or in lieu of the above.

Among advantages of certain embodiments of the presently disclosed subject matter as described herein, is the ability to perform accurate defect detection without requiring ground truth labeled data. This may be enabled by the novel loss function used to train the detection network, which combines the predicted defect map with the difference image. The difference image serves as a surrogate guide, allowing the network to focus on regions with significant discrepancies that likely indicate defects. This approach eliminates the need for extensive manual labeling, reducing time and effort, while maintaining high detection accuracy.

Among advantages of certain embodiments of the presently disclosed subject matter as described herein, is the capability of single-image detection. By leveraging the learned representations from the reconstruction network and the confidence learning approach, the detection network can accurately detect defects using only a single input image. This simplifies the defect detection process by eliminating the need for acquiring reference images, which can be time-consuming and resource-intensive. This reduction in complexity streamlines the examination workflow, making it faster and more efficient, and eliminates the need for precise alignment with reference images.

Among advantages of certain embodiments of the presently disclosed subject matter as described herein, is the implementation of confidence learning to enhance prediction reliability. This may be achieved through the incorporation of a first term in the loss function which ensures that the network focuses on regions where the difference image indicates a significant likelihood of defects, and a regularization term which penalizes overly confident prediction values in the defect map. By using the logarithmic function E[log(c(x))], the loss function ensures that the detection network assigns high confidence/certainty values only in regions where defects are strongly indicated by the difference image. This guiding mechanism results in more reliable and confident predictions, improving the overall robustness and accuracy of defect detection.

Among advantages of certain embodiments of the presently disclosed subject matter as described herein, is the ability to utilize self-supervised learning to continuously improve the detection network. This is enabled by using the defect maps generated by the detection network as label data for corresponding runtime images. By including these labeled images in a new training set, the system can further train a supervised detection network, leveraging the high-quality labels generated through self-supervised processes. This method significantly reduces the dependency on manually labeled data, supports continuous learning, and adapts to new defect patterns and variations in manufacturing processes.

Among advantages of certain embodiments of the presently disclosed subject matter as described herein, is the faster and more efficient training process of the detection network. This is enabled by initializing the detection network with the parameters of the trained reconstruction network. By duplicating or copying the network parameters from the reconstruction network, the detection network inherits a rich set of learned features and representations relevant to defect detection. This initialization provides a strong starting point, speeding up convergence, enhancing stability, and reducing the computational resources required for training the detection network from scratch.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the present discussions, it is appreciated that throughout the specification discussions utilizing terms such as “obtaining”, “examining”, “detecting”, “processing”, “using”, “providing”, “aligning”, “acquiring”, “penalizing”, “guiding”, “training”, “optimizing”, “including”, or the like, refer to the action(s) and/or process(es) of a computer that manipulate and/or transform data into other data, said data represented as physical, such as electronic, quantities and/or said data representing the physical objects.

The terms “computer”, “computer-based system” or “computerized system” should be expansively construed to cover any kind of hardware-based electronic device with a data processing circuitry (e.g., digital signal processor (DSP), a graphics processing unit (GPU), a field programmable gate array (FPGA), including, by way of non-limiting example, the examination system, the defect detection system, and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of data and/or instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates including wafers, masks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review, and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes (SEM), atomic force microscopes (AFM), optical inspection tools, etc.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limiting to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results such as measured images are analyzed, for example, by employing image-processing techniques. Note that, unless specifically stated otherwise, the term “metrology”, or derivatives thereof used in this specification, is not limited with respect to measurement technology, measurement resolution, or size of inspection area.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as “false alarm” defect) which can be disregarded because it has no effect on the functionality of the completed device and does not impact yield.

The term “runtime” used in this specification should be expansively construed to cover the on-line inspection/examination process in the fabrication plant (FAB) where production wafers are fabricated. In the context of defect detection in semiconductor specimens, “runtime” refers to the phase during which the trained detection network is employed to analyze new, unseen runtime images of semiconductor specimens. During runtime, the detection network processes these images to generate defect maps. This phase occurs after the detection network has been fully trained and is in use for actual defect detection in a production or operational environment. In contrast, a training or setup phase refers to the phase during which the detection network is developed and optimized to perform its intended task of defect detection prior to its deployment in runtime/production phase.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats as, by way of non-limiting examples, GDSII format, OASIS format, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data). Depending on the specific way of scanning (e.g., one-dimensional scan such as line scanning, two-dimensional scan in both x and y directions, or dot scanning at specific spots, etc.), image data can be represented in different formats, such as, e.g., as a gray level profile, a two-dimensional image, or discrete pixels, etc. It is to be noted that in some cases the image data referred to herein can include, in addition to images (e.g., captured images, processed images, etc.), numeric data associated with the images (e.g., metadata, hand-crafted attributes, etc.). It is further noted that images or image data can include data related to a processing step/layer of interest, or a plurality of processing steps/layers of a specimen.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system of runtime defect detection in a semiconductor specimen, the system comprising a processing circuitry configured to:
obtain a runtime image of the specimen; and
process, by a detection network, the runtime image to obtain a defect map indicating probabilities of defect distribution thereof, wherein the detection network is previously trained unsupervised in a training phase, comprising, for a training image:
obtaining a reference image of the training image;
processing, by a detection network to be trained, the training image to generate a predicted defect map thereof; and
optimizing the detection network to be trained using a loss function constructed based on the predicted defect map and a difference image between the training image and the reference image.

2. The computerized system according to claim 1, wherein the reference image is a synthetic reference image generated by a reconstruction network.

3. The computerized system according to claim 2, wherein the reconstruction network is previously trained in a first step of the training phase using a training set comprising one or more pairs of training images, each pair including a defective image and a corresponding defect-free image.

4. The computerized system according to claim 3, wherein the reconstruction network is trained by: for each pair of training images, processing the defective image by the reconstruction network to obtain a predicted image, and optimizing the reconstruction network to minimize a difference between the predicted image and the defect-free image.

5. The computerized system according to claim 3, wherein the detection network is trained in a second step of the training phase upon the reconstruction network being trained, where the detection network is initialized based on model parameters of the trained reconstruction network.

6. The computerized system according to claim 1, wherein the loss function comprises a first component calculated as a product or ratio of the difference image and predicted defect map.

7. The computerized system according to claim 6, wherein the first component enables to align the predicted defect map with potential defects indicated by the difference image, thus emphasizing regions in the predicted defect map that correlate with significant differences in the difference image.

8. The computerized system according to claim 6, wherein the loss function comprises a second component as a regularization term for penalizing overly confident prediction values in the predicted defect map, thus guiding the detection network to make reliable prediction.

9. The computerized system according to claim 1, wherein the detection network, upon being trained, is used for single-image defect detection in runtime without reference image acquisition.

10. The computerized system according to claim 1, wherein the defect map is usable as label data of the runtime image, and wherein the processing circuitry is further configured to include the runtime image and the defect map in a new training set, and using the new training set to train a supervised detection network.

11. A computerized method of training a detection network usable for defect detection in a semiconductor specimen, the method comprising:
obtaining a plurality of training images of a training specimen without ground truth label data thereof;
for each given training image, obtaining a reference image thereof;
processing, by the detection network, the given training image to obtain a predicted defect map indicating probabilities of defect distribution thereof; and
optimizing the detection network using a loss function constructed based on the predicted defect map and a difference image between the training image and the reference image.

12. The computerized method according to claim 11, further comprising: processing, by a reconstruction network, each given training image to generate a reference image thereof.

13. The computerized method according to claim 12, wherein the reconstruction network is previously trained in a first training step using a training set comprising one or more pairs of training images, each pair including a defective image and a corresponding defect-free image.

14. The computerized method according to claim 12, further comprising training the reconstruction network by: for each pair of training images comprising a defective image and a corresponding defect-free image, processing the defective image by the reconstruction network to obtain a predicted image, and optimizing the reconstruction network to minimize a difference between the predicted image and the defect-free image.

15. The computerized method according to claim 13, wherein the detection network is trained in a second training step upon the reconstruction network being trained, and wherein the method further comprises initializing the detection network based on model parameters of the trained reconstruction network.

16. The computerized method according to claim 11, wherein the loss function comprises a first component calculated as a product or ratio of the difference image and predicted defect map.

17. The computerized method according to claim 16, wherein the first component enables to align the predicted defect map with potential defects indicated by the difference image, thus emphasizing regions in the predicted defect map that correlate with significant differences in the difference image.

18. The computerized method according to claim 16, wherein the loss function comprises a second component as a regularization term for penalizing overly confident prediction values in the predicted defect map, thus guiding the detection network to make reliable prediction.

19. The computerized method according to claim 11, further comprising including the runtime image and the defect map in a new training set, the defect map serving as label data of the runtime image, and using the new training set to train a supervised detection network.

20. A non-transitory computer readable storage medium tangibly embodying a program of instructions that, when executed by a computer, cause the computer to perform a method of runtime defect detection in a semiconductor specimen, the method comprising:
obtaining a runtime image of the specimen; and
processing, by a detection network, the runtime image to obtain a defect map indicating probabilities of defect distribution thereof, wherein the detection network is previously trained unsupervised in a training phase, comprising, for a training image:
obtaining a reference image of the training image;
processing, by a detection network to be trained, the training image to generate a predicted defect map thereof; and
optimizing the detection network to be trained using a loss function constructed based on the predicted defect map and a difference image between the training image and the reference image.
